(19) United States
(12) Patent Application Publication
(10) Pub. No.: US 2005/0009976 A1
(43) Pub. Date: Jan. 13, 2005

(54) Delamination-resistant, barrier polyamide compositions for 3-layer pet beverage bottles

(75) Inventors: Murali Krishna Akkapeddi, Lake Hopatcong, NJ (US); Edward Peter Socci, Stewartsville, NJ (US); Timothy James Kraft, Pompton Plains, NJ (US); Jeffrey Donald Pratt, Budd Lake, NJ (US)

Correspondence Address: Richard S. Roberts;Roberts & Mercanti, L.L.P., P.O. Box 484, Princeton, NJ, 08542-0484, US

(73) Assignee: Honeywell International, Inc.

(21) Appl. No.: 10/617,109

(22) Filed: Jul. 10, 2003

(51) Int. Cl. C08K 3/34

(52) U.S. Cl. 524/445

(57) ABSTRACT

Gas barrier polyamide compositions exhibiting a low crystallization rate and good coinjection stretch blow moldability with polyethylene terephthalate (PET) to enable the fabrication of clear, high barrier multilayer PET bottles that have a long shelf life.

### BACKGROUND OF THE INVENTION

1. Field of the Invention

The invention relates to polyamide compositions. More particularly, the invention pertains to gas barrier polyamide compositions exhibiting a low crystallization rate and good coinjection stretch blow moldability with polyethylene terephthalate (PET) to enable the fabrication of clear, high barrier multilayer PET bottles that have a long shelf life.

2. Description of the Related Art

It is well known in the art to provide thermoplastic packaging articles such as films, bottles, containers, and the like, which are useful for food and beverage packaging. Many such articles are made of multiple layers of different plastics in order to achieve the desired barrier properties. For example, U.S. Pat. Nos. 5,055,355 and 5,547,765 teach laminates of polyamides and ethylene vinyl alcohol copolymers which have good oxygen barrier properties.

In order to enhance freshness preservation, it is a standard practice to package food and beverage products within a packaging structure composed of laminated sheets of two or more plastics. Such packaging structures generally include a barrier plastic layer which has a low permeability to oxygen. Low oxygen permeability is a paramount concern in the beverage industry because absorption of oxygen through package walls typically causes deterioration of the stored product.

It is commonly known in the art of food and beverage packaging to provide packaging films that contain a polyethylene terephthalate resin. Polyethylene terephthalate, or PET, bottles are currently used in a wide variety of packaging applications, particularly for the packaging of various beverage products such as carbonated soft drinks, water, tea, fruit juices, sports and energy drinks. The commercial success of PET bottles in replacing the glass bottles in food and beverage packaging applications is due largely to its unique combination of desirable properties such as light weight, clarity, toughness, gas barrier and ease of recyclability. However, the monolayer PET bottles do not have a sufficiently high oxygen or carbon dioxide (CO₂) gas barrier needed for packaging oxygen sensitive beverages such as beer and orange juice or even carbonated beverages in the small, single-serve size (e.g., 250 mL) bottles. In the case of carbonated soft drink applications, the CO₂ gas barrier of PET is currently adequate enough for its popular use in large size bottles, i.e. ≧1 liter. On the other hand, the high surface area to volume ratio in small size bottles leads to more gas permeation per unit volume, causing an in increase in the oxygen ingress from air into the bottle or an increase in the permeation loss of carbon dioxide gas out of the bottle. Thus, in monolayer PET soda bottles of small size (e.g. 350 mL), greater than 10% CO₂ loss occurs in just 4-5 weeks of storage and greater than 15% carbonation loss in less than 8 weeks of storage without refrigeration at room temperature and humidity conditions. Similarly, for the packaging of oxygen-sensitive beverage products such as orange juice and beer, monolayer PET bottles, in single-serve small size, do not offer sufficient oxygen barrier to give the desired storage shelf-life of greater than 6 months at room temperature. Hence there is a great need for improved gas barrier, clear plastic materials for specific use in long shelf life beverage bottle applications.

One way to overcome this poor barrier property is to increase the wall thickness of PET bottles. However, such thicker bottles are generally limited to packaging oxygen sensitive foods and beverages in large, multi-serve containers. This is because as the ratio of packaging material versus package volume increases, the cost of packaging increases more than the value of the stored product. Thus, the availability of beverages and food in single serve PET bottles and packages is limited.

Another way to overcome this insufficient gas barrier property of PET is to join PET films with films of oxygen barrier materials. Suitable oxygen barriers include ethylene vinyl alcohol (EVOH), nylon and blends thereof. For example, one common construction is a three layered film having a central EVOH layer flanked by thick, pure PET layers. This central EVOH layer is a high barrier polymer that exhibits barrier properties by slowing the permeability of oxygen through the container wall. However, the adhesive strength between the EVOH layer and the layers of PET is weak. Thus, it is not uncommon for bottles formed with three layered constructions of PET and EVOH or certain nylons and nylon blends to delaminate readily due to the poor interlayer adhesion between adjacent layers, particularly after the films are stretch blow molded and filled with carbonated beverages under pressure or hot filled with juices. Such a delamination of the barrier material layer often increases after some storage time or moisture absorption, most likely due to the shrinkage caused by chain relaxation and post-crystallization of the barrier resin. The layer delamination in the soda filled bottles is further aggravated by impact stresses such as dropping the bottle from a height or impacting on the sidewalls. Stress concentration upon sudden impacts causes the initiation of layer delamination if the adhesion is poor.

The layer delamination problem in the multilayer PET bottles is definitely undesirable not only for the retention of the structural integrity and aesthetic appearance of the bottle, but also for retaining its impact toughness and barrier performance. However, it must be noted that such a delamination resistance in the multilayer bottles must be achieved only without using any chemical coupling or reactive tie-layers. No permanent chemical adhesion between the layers is desired because it would inhibit the post-recycling of the bottles, the preferred process that consists of chopping the bottles into small pieces and separating the individual layers and materials by using air or aqueous solvent based separation techniques utilizing the bulk density differences between the PET and the barrier layer films. Additionally, although there are several other higher barrier resins, they are either too expensive or unsuitable to be processed into clear monolayer bottles.

Hence, it is necessary that the delamination resistance properties in the multilayer bottles must be achieved only by maintaining just a sufficient level of interlayer Vanderwaal's type physical adhesion forces and not via a chemical bond induced adhesion. Such interlayer physical adhesion and dimensional stability is believed to be controlled by the crystallization behavior of the barrier nylon composition and the PET during the bottle processing. This invention provides a solution to this practically significant problem in multilayer PET bottles by formulating specific types of polyamide layer compositions that would exhibit the desired high delamination resistance as well as retain the high gas barrier properties needed for extended storage shelf-life. The invention describes in particular a polyamide barrier resin having a suppressed crystallization rate. The barrier resin comprises a blend of nylon-MXD6 with other miscible nylons such as nylon 6 and an amorphous nylon such as nylon 6I/6T. Such a blend has been found to retain high gas barrier properties while exhibiting lower crystallinity and crystallization tendencies enough to cause high adhesion to PET in multilayered molded containers. Accordingly, multilayered packaging films including both PET and the polyamide composition of the invention retain the benefits of both materials while overcoming the problems of the art discussed herein.

### SUMMARY OF THE INVENTION

The invention provides a polyamide composition comprising a slow crystallizing blend of (i) an aliphatic, crystallizable polyamide homopolymer or copolymer or polyamide nanoclay; (ii) a semi-aromatic, crystallizable polyamide; and (iii) a semi-aromatic, amorphous polyamide.

The invention also provides a multilayer film which comprises:
a) at least one polyamide composition layer comprising a slow crystallizing polyamide blend of:
(i) an aliphatic, crystallizable polyamide homopolymer or copolymer or polyamide nanoclay;
(ii) a semi-aromatic, crystallizable polyamide; and
(iii) a semi-aromatic, amorphous polyamide; and
b) at least one thermoplastic polymer layer on one or both sides of said at least one polyamide composition layer.

The invention also provides a process for producing a multilayer article which comprises:
(a) melting a polyamide blend comprising of (i) an aliphatic, crystallizable polyamide homopolymer or copolymer, or polyamide nanocomposite; (ii) a semi-aromatic, crystallizable polyamide; and (iii) a semi-aromatic, amorphous polyamide;
(b) separately melting a thermoplastic polymer;
(c) coextruding, casting, blowing, thermoforming, blow molding or co-injecting the polyamide blend and thermoplastic polymer composition into a multilayer article; and
(d) cooling the article.

The invention also provides a process for producing a multilayer article which comprises:
(a) melting a polyamide blend comprising of (i) an aliphatic, crystallizable polyamide homopolymer or copolymer, or polyamide nanocomposite; (ii) a semi-aromatic, crystallizable polyamide; and (iii) a semi-aromatic, amorphous polyamide;
(b) separately melting a thermoplastic polymer;
(c) co-injecting molding the mixture and thermoplastic polymer composition into a multilayer pre-form;
(d) reheating the pre-form; and
(e) blow molding the pre-form into a multilayer article.

### BRIEF DESCRIPTION OF THE DRAWING

FIG. 1 illustrates the carbonation retention behavior of 3-layer PET/PA/PET soda bottles (500 mL) containing the delamination-resistant polyamide compositions of this invention.

### DETAILED DESCRIPTION OF THE PREFERRED EMBODIMENT

According to the invention, an improved delamination-resistant barrier polyamide composition is provided that is a slow crystallizing polyamide blend which is suitable for coinjection stretch-blow molding with a thermoplastic polymer, preferably polyethylene terephthalate. The polyamide composition comprises a slow crystallizing blend of (i) an aliphatic, crystallizable polyamide homopolymer or copolymer or polyamide nanoclay; (ii) a semi-aromatic, crystallizable polyamide; and (iii) a semi-aromatic, amorphous polyamide.

The polyamides used in the preparation of the polyamide blend of this invention may be obtained from commercial sources or may be prepared by using the conventional polycondensation polymerization techniques. Suitable semi-crystalline, aliphatic polyamides nonexclusively include homopolymers such as poly(6-aminohexanoic acid) (PA-6), also known as poly(caprolactam), poly(hexamethylene adipamide) (PA-6,6), poly(7-aminoheptanoic acid) (PA-7), poly(10-aminodecanoic acid) (PA-10), poly(11-aminoundecanoic acid) (PA-11), poly(12-aminododecanoic acid) (PA-12), poly(hexamethylene sebacamide) (PA 6,10), poly(hexamethylene azelamide) (PA-6,9), poly(tetramethylene adipamide (PA-4,6), caprolactam/hexamethylene adipamide copolymer (PA-6,6/6), hexamethylene adipamide/caprolactam copolymer (PA-6/6,6) and the like, as well as copolymers and mixtures thereof. Of these, preferred aliphatic polyamides include polycaprolactam, commonly referred to as PA-6 (nylon 6), and polyhexamethylene adipamide, commonly referred to as PA-6,6 (nylon 6,6), and mixtures thereof. Of these, nylon 6 is the most preferred.

Preferably, the semi-aromatic, crystallizable polyamide used in this invention comprises of a homopolymer or a copolymer having a molecular weight of from about 10,000 to about 100,000 and a glass transition temperature (T_{g}) of from about 70° C. to about 120° C., a melting point (Tₘ) of from about 200° C. to 300° C. and a high gas barrier property such as characterized by a low CO₂ permeability of from about 0.05 to about 5 cc.mil/100 in²/atm/day in air @ 80% relative humidity (RH), more preferably from 0.1 to 2 and most preferably <1 cc.mil/100 in²/day in air at atmospheric pressure and at 80% relative humidity.

The semi-aromatic, crystallizable polyamides may comprise any one of the following three types, or a combination thereof:

Type I: A polyamide derived from the polycondensation of an aralkylene diamine with linear aliphatic or aromatic dicarboxylic acid monomers represented by the formula:
—HN(CH₂)ₙAr(CH₂)ₙNHCO-Z-CO—
wherein n=1-3, Ar is a substituted or unsubstituted arylene group such as m- or p-phenylene group and Z=an alkylene group of C₄ to C₈ or an unsubstituted arylene unit of C₆ to C₁₄, such as phenylene, naphthylene, biphenylene, anthracenylene or phenanthrenylene.

Type II: A polyamide derived from the polycondensation of a linear aliphatic diamine with an equivalent mixture of aromatic and aliphatic dicarboxylic acid monomers of which at least 50% is aromatic, and the polyamide having a general formula of:
—HN(CH₂)ₙNH—[COArCO—]ₓ—[CO(CH₂)ₘ CO]_{y}—
where n=1 to 3; m=4 to 8; x+y=1 and Ar is a substituted or unsubstituted arylene group such as m- or p-phenylene group.

Type III: A polyamide derived from the polycondensation of an ω-aminoalkylaroic acid represented by the formula:
—HN(CH₂)ₙArCO—
wherein n=1-3 and Ar is a substituted or unsubstituted arylene group such as phenylene, naphthylene, biphenylene, or 4,4′-oxydiphenylene, phenanthrylene, anthracenylene groups.

It is preferred that in all of the monomer units described above neither the aliphatic nor the aromatic moieties contain any pendant groups or substituents, since the lack of such pendant groups is generally known to facilitate high degree of chain packing and low free volume in the polymers and hence leading to good gas barrier properties. Examples of crystallizable, semi-aromatic polyamides nonexclusively include PA-MXD6, PA-MXD6/T, PA-MXD6/66 and the like. Of these, PA-MXD6 is commercially available from Mitsubishi Gas Chemical Co., Japan and their North American subsidiary, under commercial the name of Nylon-MXD6 (Grades 6001, 6007 and 6121).

As stated above, the semi-aromatic, crystallizable polyamide of the invention may comprise a semi-aromatic, crystallizable polyamide having a generalized repeating unit structure which comprises any one of types 1, II or III, or a combination of I and II, I and III, II and III, or I, II and III.

General procedures useful for the preparation of crystallizable, semi-aromatic polyamides are well known to the art. Such are the melt polycondensation reaction products of a stoichiometric/equivalent mixture of a suitable diamine and dicarboxylic acid monomers. Preparation of suitable polyamides such as PA-MXD6 are described in the U.S. Pat. Nos. 4,433,136 and 4,438,257 which are incorporated herein by reference.

Suitable diamines for making the of crystallizable semi-aromatic polyamides of type I include the aralkylene diamines having the general formula:
H₂N(CH₂)ₙ Ar(CH₂)ₙ NH₂
wherein n has an integer value of 1 to 3 and Ar is a substituted or unsubstituted arylene group preferably with no ring substituents, such as m- or p-phenylene, 2,6-naphthylene, 4,4′ biphenylene, 4,4′-oxy diphenylene, etc. Specific aralkylene diamines (where n=1) such as m- or p-xylylene diamine are particularly preferred.

Suitable diamines for making the of crystallizable semi-aromatic polyamides of type II are the linear alkylene diamines with no pendant groups and having the general formula:
H₂N(CH₂)ₙ NH₂
wherein n has an integer value of 4 to 12. Alkylene diamines wherein n=4-7 are particularly preferred. Of these, hexamethylene diamine (n=6) is the most preferred.

Suitable dicarboxylic acids for making the crystallizable, semi-aromatic polyamides of both type I & II have the general formula of:
HOOC-Z-COOH
wherein Z is representative of a divalent short chain (<10 C) aliphatic diacid with no pendant groups such as adipic acid, azelaic acid, sebacic acid or an unsubstituted aromatic dicarboxylic acid such as terephthalic acid, 2,6-naphthalene dicarboxylic acid etc, and mixtures thereof.

Suitable amino acid type monomers for making the crystallizable semi-aromatic polyamides of type III include the ω-aminoalkylaroic acids with a general formula:
H₂N(CH₂)ₙ—Ar—COOH
wherein n=1 to 3 and Ar is a substituted or unsubstituted arylene group preferably containing no ring substituents, such as m- or p-phenylene, 1,4- or 2,6-Naphthylene, 4,4′-Biphenylene or 4,4′-oxydiphenylene and the like.

Preferably, the amorphous, non-crystallizable semi-aromatic polyamide of the invention comprises a homopolymer or a random copolymer having a molecular weight of from about 10,000 to about 100,000, a T_{g} of from about 70° C. to 200° C. and good oxygen barrier property such as an oxygen permeability of <1 cc.mil/100 in²/atm day in air. Semi-aromatic nylons comprising aromatic monomer units and linear aliphatic monomer units, without pendant groups or substituents, are particularly preferred in this invention since they are known to exhibit intrinsically good gas barrier properties due to their low free volume or high chain packing density. Examples of such amorphous, semi-aromatic polyamides nonexclusively include poly(hexamethylene isophthalamide-co-terephthalamide) (PA-6,I/6,T), poly (hexamethylene isophthalamide) (PA-6I) and other such polyamides abbreviated as, PA-MXDI, PA-6/MXDI, PA-6/6N and the like. PA-6I/6T is commercially available from EMS corporation of Zurich, Switzerland, under the name Grivory G21, or from DuPont of Wilmington, Del., USA, under the name Selar PA3426 or Selar PA2072. In contrast, semi-aromatic polyamides composed of monomer units with bulky pendant groups or bulky cycloaliphatic rings are poor gas barrier materials and hence are not preferred for making the high barrier oxygen-scavenging compositions of this invention. An example of such a polyamide is poly(2,4,4-trimethyl hexamethylene terephthalamide), sold by Hüls USA of Somerset, N.J., USA under the name Trogamid.

General procedures useful for the preparation of amorphous, semi-aromatic polyamides are well known to the art. Such are the reaction products of diacids with diamines. Useful diacids for making such polyamides include dicarboxylic acids of the general formula:
HOOC-Z—COOH
wherein Z is representative of a divalent short chain (<10 C) aliphatic diacid such as adipic acid, azelaic acid, sebacic acid or more preferably an unsubstituted aromatic dicarboxylic acid such as isophthalic acid, terephthalic acid, 2,6-naphthalene dicarboxylic acid, and the like.

Suitable diamines for making polyamides include aliphatic diamines having the formula:
H₂N(CH₂)ₙNH₂
wherein n has an integer value of 1-10 and/or an aralkylene diamine of general formula:
H₂N(CH₂)ₘ—Ar—(CH₂)ₘNH₂
wherein m is an integer value of 1 to 4, more preferably from 1 to 3 and most preferably 1, and Ar is a substituted or unsubstituted arylene group, preferably an unsubstituted phenylene, unsubstituted naphthylene, or unsubstituted biphenylene.

Aliphatic diamines include such compounds as trimethylenediamine, tetramethylenediamine, pentamethylenediamine, hexamethylenediamine, octamethylenediamine, decamethylenediamine, and the like. Aralkylene diamines such as m- or p-xylylene diamine are particularly suited.

Suitable amorphous semi-aromatic polyamides nonexclusively include poly(hexamethylene isophthalamide-co-terephthalamide) (PA-6,I/6,T), poly(hexamethylene isophthalamide) (PA-6,I), poly(tetramethylenediamine-co-isophthalic acid) (PA-4,I), and the like, and other polyamides abbreviated as PA-MXDI, PA-6/MXDT/I, PA-6,6/6I, and the like. Other suitable polyamides are described in U.S. Pat. Nos. 4,826,955 and 5,541,267, which are incorporated herein by reference.

In the most preferred embodiment of the invention, the aliphatic, crystallizable polyamide homopolymer or copolymer comprises nylon 6 or nylon 6 nanocomposite; the semi-aromatic, crystallizable polyamide comprises PA-MXD6; and the semi-aromatic, amorphous polyamide comprises PA-6I/6T.

The aliphatic, crystallizable polyamide homopolymer or copolymer, or polyamide nanoclay, of the invention preferably comprises from about 5% to about 90% by weight of said polyamide composition, more preferably from about 15% to about 75%, most preferably from about 30% to about 50% by weight of said polyamide composition. The semi-aromatic, crystallizable polyamide preferably comprises from about 5% to about 90% by weight of said polyamide composition, more preferably from about 20% to about 70%, most preferably from about 30% to about 60% by weight of said polyamide composition. The a semi-aromatic, amorphous polyamide preferably comprises from about 5% to about 90% by weight of said polyamide composition, more preferably from about 10% to about 70%, most preferably from about 10% to about 25% by weight of said polyamide composition.

The polyamide blend of this invention preferably exhibits a slow crystallization behavior similar to that of PET, characterized by no or slow onset of crystallization, as determined by the differential scanning calorimetry (DSC) crystallization exotherm (Tcc) peak that occurs upon cooling the melt from 280° C. at a programmed cooling rate of 20° C./min PET exhibits a Tcc of about 190° C. when cooled slowly from melt (10-20(C/min), approximately 70° C. below its crystalline melting point. However, PET shows no detectable Tcc at a faster cooling rate such as 80° C./min, indicating suppressed crystallization tendency under fast cooling conditions such as in injection molding. Hence in order to match the crystallization behavior of PET during coinjection stretch-blow molding of bottles, the barrier layer resin should also crystallize slowly or not crystallize at all. Thus, the polyamide composition of this invention were preferably designed to exhibit either no Tcc (no tendency for crystallization) or a low Tcc or crystallization temperature of about 150° C. or less, upon cooling from the melt at a cooling rate of 20° C./min in a DSC apparatus.

The polyamide composition of this invention preferably exhibits a low degree of crystallinity after injection molding, preferably ranging from about 0% to about 30%, more preferably from about 5% to about 25% and most preferably from about 10% to about 20% as determined by differential scanning calorimetry or wide angle X-ray diffraction (WAXD) techniques.

In a preferred embodiment of the invention, the polyamide composition further comprises a nanometer scale dispersed clay, known in the art as a nanoclay. Suitable clays are described in U.S. Pat. No. 5,747,560, which is incorporated herein by reference. Preferred clays non-exclusively include a natural or synthetic phyllosilicate such as montmorillonite, hectorite, vermiculite, beidilite, saponite, nontronite or synthetic fluoromica, which has been cation exchanged with a suitable organoammonium salt. A preferred clay comprises montmorillonite, hectorite or synthetic fluoromica, more preferably montmorillonite or hectorite, and most preferably montmorillonite. A preferred organoammonium cation for treating the clay comprises N,N′,N″,N′″Bis(hydroxyethyl), methyl, octadecyl ammonium cation or ω-carboxy alkylammonium cation, i.e., the ammonium cation derived such ω-aminoalkanoic acids as 6-aminocaproic acid, 11-aminoundecanoic acid, 12-aminododecanoic acid.

Preferred fine dispersions of nanometer scale silicate platelets may be obtained via an in-situ polymerization of polyamide forming monomer(s) or via melt compounding of polyamide in the presence of the organoammonium salt treated clay. In the preferred embodiment of the invention, the nanoclay is compounded with the aliphatic, crystallizable polyamide homopolymer or copolymer of the invention to form a polyamide nanocomposite. This polyamide nanocomposite is then preferably blended with the semi-aromatic, crystallizable polyamide and a semi-aromatic, amorphous polyamide of the invention.

The nanoclay is preferably exfoliated throughout the polyamide with which it is compounded, and is preferably a platelet-type nanoclay. Such platelet-type nanoclays are well known in the art. The nanoclay used herein preferably has an average platelet thickness of at least about 1 nm, preferably from about 1 nm to about 100 nm. The nanoclay preferably has an average length and an average width of at least about 20 nm, more preferably an average length and width each ranging from about 50 nm to about 700 nm. It is preferably present in the overall polyamide composition in an amount of from more than 0% to about 10% by weight, more preferably from about 0.5% to about 6% and most preferably from about 0.8% to about 4%.

The polyamide composition of the invention may optionally also include one or more conventional additives whose uses are well known to those skilled in the art. The use of such additives may be desirable in enhancing the processing of the composition as well as improving products or articles formed therefrom. Examples of such include: oxidative and thermal stabilizers, lubricants, release agents, flame-retarding agents, oxidation inhibitors, oxidation scavengers, dyes, pigments and other coloring agents, ultraviolet light absorbers and stabilizers, organic or inorganic fillers including particulate and fibrous fillers, reinforcing agents, nucleators, plasticizers, as well as other conventional additives known to the art. Such may be used in amounts, for example, of up to about 10% by weight of the overall composition. Representative ultraviolet light stabilizers include various substituted resorcinols, salicylates, benzotriazole, benzophenones, and the like. Suitable lubricants and release agents include stearic acid, stearyl alcohol, and stearamides. Exemplary flame-retardants include organic halogenated compounds, including decabromodiphenyl ether and the like as well as inorganic compounds. Suitable coloring agents including dyes and pigments include cadmium sulfide, cadmium selenide, titanium dioxide, phthalocyanines, ultramarine blue, nigrosine, carbon black and the like. Representative oxidative and thermal stabilizers include the Period Table of Element's Group I metal halides, such as sodium halides, potassium halides, lithium halides; as well as cuprous halides; and further, chlorides, bromides, iodides. Also, hindered phenols, hydroquinones, aromatic amines as well as substituted members of those above mentioned groups and combinations thereof. Exemplary plasticizers include lactams such as caprolactam and lauryl lactam, sulfonamides such as o,p-toluenesulfonamide and N-ethyl, N-butyl benylnesulfonamide, and combinations of any of the above, as well as other plasticizers known to the art.

Preferably the polyamide composition is produced via melt extrusion compounding of a pellet blend of the individual polyamide components pre-mixed at the desired ratio. The composition is formed by intimately mixing the polyamide components in the molten state in a suitable melt-mixing apparatus such as a single-screw or twin-screw extruder. Typical melting temperatures range from about 230° C. to about 300° C., more preferably from about 235° C. to about 280° C. and most preferably from about 240° C. to about 260° C. for nylon 6 and its copolymers. The melt mixing process is preferably conducted for a period of time suitable to attain a substantially uniform blend. Such may easily be determined by those skilled in the art. The composition may then be cooled and cut into pellets for further processing such as for fabrication of films or bottles.

The polyamide composition of this invention may be used to produce various single layered or multilayered films, articles, bottles, containers, and the like using conventional processing techniques. In the most preferred embodiment of the invention, a layer of the polyamide composition is joined with at least one layer of a thermoplastic polymer to form a multilayered film. In particular, the polyamide compositions of this invention are most suited and most preferred for the coinjection stretch blow molding of multilayered bottles comprising at least one layer of a polyester, e.g. PET, attached to at least one layer of the polyamide composition of the invention. In one particularly preferred multilayered construction of the invention, a single layer of the polyamide composition of the invention is attached on each surface to a layer of PET. Alternately, the thermoplastic polymer may comprise a polyolefin or material suitable for forming multilayered films, however, PET is preferred for its particularly desirable properties.

Processing techniques for making films, sheets, containers and bottles are all well known in the art. One common technique for forming multilayer films is coextrusion. In a typical coextrusion process, for example, the polymeric material for the individual layers, are fed into infeed hoppers of a like number of extruders, each extruder handling the material for one or more of the layers. The melted and plasticated streams from the individual extruders are fed into a single manifold co-extrusion die. While in the die, the layers are juxtaposed and combined, then emerge from the die as a single multiple layer film of polymeric material. After exiting the die, the film is cast onto a first controlled temperature casting roll, passes around the first roll, and then onto a second controlled temperature roll, which is normally cooler than the first roll. The controlled temperature rolls largely control the rate of cooling of the film after it exits the die. Additional rolls may be employed. In another method, the film forming apparatus may be one which is referred to in the art as a blown film apparatus and includes a multi-manifold circular die head for bubble blown film through which the plasticized film composition is forced and formed into a film bubble which may ultimately be collapsed and formed into a film. Processes of coextrusion to form film and sheet laminates are generally known. Typical coextrusion techniques are described in U.S. Pat. Nos. 5,139,878 and 4,677,017.

Films of the invention and their individual layers may optionally be oriented prior to being attached or prior to being formed into an article. For the purposes of the present invention the term draw ratio is an indication of the increase in the dimension in the direction of draw. Preferably, in the present invention the polyamide composition film or thermoplastic polymer film(s) is/are drawn to a draw ratio of from 1.5:1 to 5:1 uniaxially in at least one direction, i.e. its longitudinal direction, its transverse direction or biaxially in each of its longitudinal and transverse directions. Preferably, the film or films are simultaneously biaxially oriented, for example orienting a plasticized film in both the machine and transverse directions at the same.

Multilayered barrier bottles and articles of this invention may be formed by any conventional technique for making the bottles and containers, including coinjection stretch-blow molding and coextrusion blow molding, and the like. A more preferred method for making the multilayer bottles is by coinjection stretch-blow molding. Typically the bottle molding process consists of an injection molding process which softens the thermoplastic polymer in a heated cylinder, injects it while molten under high pressure into a closed pre-form mold, cooling the mold to induce solidification of the polymer, and ejecting the molded pre-form from the mold. The injection molded pre-form is then heated to a suitable orientation temperature, often in about the 90° C. to 120° C. range, and is then stretch-blow molded. The latter process consists of first stretching the hot pre-form in the axial direction by mechanical means such as by pushing with a core rod insert followed by blowing high pressure air (up to about 500 psi) to stretch in the hoop direction. In this manner, a biaxially oriented blown bottle is made. Typical blow-up ratios often range from about 5:1 to about 15:1.

Such PET/polyamide multilayer bottles can be made by coinjection stretch-blow molding process similar to the injection-stretch blow molding process as described above. Preferred polyesters for coinjection stretch blow molding process include polyethylene terephthalate (PET) and its copolymers in the intrinsic viscosity (I.V.) range of about 0.5 to about 1.2 dl/g, more preferably in the I.V. range of from about 0.6 to about 1.0 dl/g and most preferably in the I.V. range of from about 0.7 to about 0.9 dl/g.

Although each layer of the multilayer structure may have a different thickness, the thickness of the polyamide composition layer or layers is/are preferably from about 1 μm to about 25 μm, more preferably from about 3 μm to about 8 μm and most preferably from about 4 μm to about 6 μm. The thickness of the thermoplastic polymer (e.g. PET) layer or layers is/are preferably from about 1 μm to about 50 μm, more preferably from about 10 μm to about 30 μm and most preferably from about 12 μm to about 25 μm. While such thicknesses are preferred, it is to be understood that other film thicknesses may be produced to satisfy a particular need and yet fall within the scope of the present invention.

The glass transition temperature (T_{g}) of the polyamide composition of this invention, as determined by differential scanning calorimetry techniques, is preferably less than about 120° C., which is generally the upper temperature limit for the neat PET's reheat stretch blow moldability into distortion-free bottles. In addition, in coinjection stretch blow molding processes for making multilayer bottles, extensive craze voiding of the polyamide layer will occur if the T_{g} of the polyamide composition exceeds about 110° C., indicating a lack of stretchability. Voiding in the polyamide layer may lead to an undesirable loss in the gas barrier properties, optical clarity and aesthetics of the bottles. Hence, the polyamide composition preferably is stretchable in the temperature range of about 90° C. to about 120° C. and therefore the polyamide composition preferably has a T_{g} of from about 40° C. to about 110° C., more preferably from about 60° C. to about 105° C. and most preferably from about 80° C. to about 95° C.

A noteworthy characteristic of the articles produced from the composition of this invention is that they exhibit excellent gas barrier properties, particularly carbon dioxide (CO₂) barrier properties. The CO₂ transmission rate may be measured by using the procedure of ASTM D-3985. In general, the films from the compositions of this invention have a CO₂ transmission rate (CO₂TR) of about less than 10 cc.mil/100 in²/day at 80% RH in air, more preferably from about 0.1 to about 5 cc.mil/100 in²/day and most preferably from about 0.1 to about 3 cc.mil/100 in²/day in a cast, unoriented form. Upon orientation during stretch blow molding of bottles, the barrier is expected to increase normally ≧2×.

The polyamide composition of the invention also preferably exhibits a slow isothermal crystallization at 180° C. (after fast cooling from melt), preferably at a rate of <15%/min, more preferably at <10%/min and most preferably a <6%/min and the time to reach peak crystallization rate (tₚₑₐₖ) is preferably greater than about 30 min, more preferably greater than about 40 min and most preferably does not crystallize under those conditions.

In summary, the invention provides high barrier polyamide blend compositions which exhibit an unusually high degree of adhesion to PET when processed as multilayer coinjection stretch blow molded PET bottles, thus providing highly delamination-resistant bottles with high level of gas barrier properties.

The following non-limiting examples serve to illustrate the invention:

### EXAMPLES

The following process and characterizations steps were conducted for the following examples and comparative examples.

Process 1: Preparation of Polyamide Blend via Melt Blending in an Extruder

For the laboratory scale melt blending of the polyamides, a Leistritz 18-mm co-rotating twin screw extruder (TSE) equipped with a K-Tron volumetric feeder was utilized. The extruder had five separately heated mixing zones and a strand extrusion die all of which were maintained at around 250° to 260° C. Typically, a pellet mixture of a crystallizable aliphatic polyamide such PA-6 or PA-6 nanocomposite (Component A), an amorphous semi-aromatic polyamide PA-6I/6T (Component B) and a crystallizable semi-aromatic polyamide such as PA-MXD6 (Component C) was pre-mixed at the desired ratio and the pellet blend was fed into the extruder hopper. The blend was then melt extruded at a screw speed of 150 rpm, a torque of 40-75%, a die pressure of 50-75 psi and a throughput rate of approximately 4.5 Kg/hr. The extrudate of the resulting polyamide blend was cooled in a quench water bath and the solidified strands were cut and pelletized as usual.

For the pilot-plant scale melt blending experiments, a 40 mm Werner-Pfleiderer (WP-40) co-rotating twin-screw extruder equipped with 10 separately heated mixing zones and a 6-hole die was used. The extruder was equipped with two downstream mixing zones (downstream to the combing mixers) consisting of kneading blocks, paddle and shear mixing elements. Subsequent to the final mixing zone and prior to the strand die the extruder was equipped with a vacuum venting zone (at zone 8). All the extruder barrel zones were generally maintained at around 250° to 260° C., except the zone #1 (near the feeder) which was kept at 220° C. The individual polyamide components A,B and C were pellet-pellet blended at the desired ratio and then fed into the extruder hopper. The blend was intensively melt mixed and extruded at screw speed of 350-375 rpm, torque of 60-75% torque and a head pressure of 1400 psi. The blend was extruded at approximately 45 Kg/hr throughput rate. After passing through the strand die, the extrudate was quenched in a 3 meter long cold water bath and then pelletized.

For the production scale (>500 kg/hr) melt compounding of the blends, both single-screw type and twin-screw type extruders were used following essentially the same procedure as above.

Process 2: Cast Film Processing

A ThermoHaake 0.75 inch single screw extruder equipped with a Killion cast take-up roll system and a 6-inch wide film die was flood fed with pellets from process 2 or other source. Extruder barrel and die temperatures were set at approximately 260° C. Extrudate passed through the slit die onto a temperature controlled cast roll (set at ambient temperature). Film thickness was adjusted via cast roll speed and/or screw speed to prepare a film with a thickness of 0.001 inch to 0.003 inch.

Process 3: Co-Injection Stretch-Blow Molding

The process used for making the 3-layer bottles comprising of the polyamide blend and PET layers, consisted of two discreet steps. In the first step, a 3-layer co-injection molding process was used to make the 3-layer bottle pre-forms with the inside/middle/outside layer structure of: PET/Polyamide blend/PET. The pre-forms were subsequently reheated and stretch blown to the desired size 3-layer bottles. The polyamide blend composition was typically 5 weight percent of the total pre-form or bottle weight.

Step I (Coinjection Molding):

The 3-layer bottle pre-forms were normally prepared either on an Arburg or Engel 200 ton Co-Injection machine with a equipped with a Kortec design co-injection head/manifold and a 4-cavity multilayer pre-form mold. On a larger scale, a Husky 48 cavity co-injection molding machine equipped with a Kortec manifold was used. The larger scale molding trials were particularly valuable in determining the consistency of the process and the delamination resistance of the polyamide layer in a large number of bottles. In all cases, the PET (typically 0.8 IV such as a bottle grade resin from Kosa) and the polyamide feeding extruder temperatures were optimally set approximately at 270° C.

| | PET feed barrel | | Polyamide feed barrel | |
|---|---|---|---|---|
| Shot size | 126.4 | mm | 79.8 | mm |
| Back Pressure | 400 | psi | 200 | psi |
| Recovery time | 2.26 | sec | 9.78 | sec |
| Fill pressure | 1539 | psi | 669 | psi |
| Fill time | 3.02 | sec | 1.58 | sec |
| Screw speed | 51 | rpm | 300-325 | rpm |
| Injection velocity | 36 | mm/sec | 58 | mm/sec |
| Hold pressure | 765 | psi | 0 | psi |
| Decompression | 0 | mm | 22 | mm |
| Cool time | 2.5 | sec | | |
| Hold time | 2.25 | sec | | |

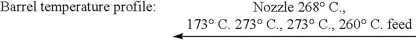

Note: Generally all the blends from the ensuing examples exhibited good layer distribution control and layer uniformity, low to no haze and very good knit line quality. Upon cutting and dissection of the barrier layer in the pre-forms showed that the PA-blend layers exhibited generally much better adhesion than the comparative examples.

Step II (Stretch Blowing Process):

Finished bottles were prepared from the above made pre-forms using a Sidel stretch blow molding machine. In a typical large scale processing operation, the machine was run at a production rate of 22,000 bottles/hour with a pre-form preheat temperature of 110° C. The stretch-blow process consists of first stretching the hot pre-form in the axial direction by mechanical means such as by pushing with a core rod insert followed by blowing high pressure air (up to about 500 psi) to stretch in the hoop direction. In this manner, a biaxially oriented blown bottle is made. Typical pre-form to bottle blow-up ratio ranges from about 5:1 to about 15:1.

Characterization

Non-Isothermal and Isothermal DSC Crystallization Measurements:

Non-isothermal and Isothermal crystallization rate measurements were made using a Perkin Elmer DSC-7 differential scanning calorimetry equipment. Dried samples of polyamide blend pellets or film pieces were heated above their melting point and their crystallization behavior upon cooling from melt was measured by (a) a non-isothermal method using a constant cooling rate such as 20° C./min, which measures the crystallization temperature (Tcc) and (b) an isothermal crystallization method at a constant temperature below the melting point such as @ 180° C. which measures the crystallization times (t_{1/2} & tₚₑₐₖ) and the rates of crystallization. Both methods can be done on the DSC simultaneously with a single sample through a combination of heating & cooling protocols as described below.

Typically the sample was first heated in the DSC apparatus from 20° C. to 280° C. at 20° C./min (step 1). This measures the melting point, Tₘ. The molten sample was then held in the same DSC at 280° C. for 5 min. (step 2). This achieves a complete melting and temperature equilibration of the sample. It is then cooled from 280° C. to 20° C. at a cooling rate of 20° C./min. (Step 3) and the resulting crystallization temperature (Tcc) peak in the DSC chart was recorded. The sample was held at 20° C. for 5 min (step 4) and then reheated to 280° C. @ 20° C./min (step 5) and the resulting melt was kept at 280° C. for 5 min. (step 6). The melt was then quickly cooled to 180° C. at 80° C./min (step 7). It was then kept at 180° C. for 60 minutes and the isothermal crystallization rate was measured during this period (step 8). The instrument records the heat flow (mW) from crystallization of the sample (extrapolated into net crystallinity) as a function of time. From this chart, the time to reach half the crystallization (t_{1/2}) or the peak crystallization rate (tₚₑₐₖ) is recorded. From the slope of the curve, a measure of rate ‘R’ (% of the net crystallinity/min) is also calculated. Polyamides which show slow crystallization are denoted by long times to reach peak crystallization (tₚₑₐₖ) or low rate (R) numbers.

The data for examples and the comparative examples is shown in Table 1.

Note: Samples which crystallize extremely slow or do not crystallize at all under these conditions, show no crystallization curves in the DSC and hence the absence of Tcc, tₚₑₐₖ or R values for some of the samples shown in the Table 1 indicates the lack of crystallization during the measurement period of 60 minutes and are included as preferred embodiments of this invention for delamination-resistant, 3-layer PET bottles, provided they also met the CO₂ barrier requirements.

Oxygen and Carbon Dioxide (CO₂) Gas Transmission Measurements on Films:

The oxygen transmission measurements were conducted on film samples with a Mocon Oxtran 2/20 apparatus equipped with SL sensors. Tests were conducted at 80% relative humidity in either air (21% oxygen) or pure oxygen (100% oxygen). Data was collected as a function of time and recorded in thickness normalized units: cc mil/100 in²/atm day.

The carbon dioxide (CO₂) gas equilibrium transmission rate measurements were conducted on 50 cm² film samples with a Mocon CO₂ transmission apparatus equipped with IR sensors. One side of the film was continuously exposed with a flow of CO₂ gas humidified to 80% RH while the other side was swept with a nitrogen carrier gas. The flux was analyzed with an IR sensor. All testing was conducted at atmospheric pressure and 23° C. Data was collected as a function of time and recorded in thickness normalized units: cc mil/100 in²/atm day.

Carbon Dioxide (CO₂) Gas Loss Tests on Carbonated Soft-Drink Bottles:

The 3-layer, PET/Polyamide/PET coinjection stretch-blow molded bottles were filled with carbonated water to 4.0 volumes of CO₂ and placed within an airtight chamber mounted onto a Permatron permeation measurement equipment. The bottles were maintained at 72° F. The sample gas within the chamber holding the bottle was sampled routinely to determine the amount of carbon dioxide ingress into the chamber from the container. The bottles are kept until they reach an equilibrium based on the last three data values.

The CO₂ loss in the carbonated soft drink 3-layer PET bottles was also tested alternatively using a Zahm Nagel test method, which consists of puncturing the seal of the bottle with a Zahm Nagel puncture device and accurately measuring the instantaneous pressure and temperature. From the pressure/temperature relationship the CO₂ gas volumes in the beverage is determined.

Optical Clarity/Haze Determination:

Barrier layer films that were extracted from bottles were evaluated for percent haze with a Haze Guard Plus stationary instrument. The specimen surface was illuminated perpendicularly and the transmitted light was measured photo-electrically using an integrated sphere (0°/diffuse geometry) which conforms to ASTM D-1003 standard.

Delamination Testing of the 3-Layer PET Soda Bottles:

(i) Ageing Test:

Two hundred bottles of ‘PET/PA/PET’ 3-layer structure were filled with the carbonated beverage under pressure (approximately 4 volumes of CO₂) and 20 bottles were opened every 2 weeks to examine visually the extent of delamination before and after opening. Generally severe delamination caused a ‘ballooning’ appearance of the layer in the bottle. In contrast to the comparative example 4, the samples of this invention showed very little or no delamination.

(ii) Drop Impact Test:

Twenty bottles made with a ‘PET/PA/PET’ 3-layer structure and filled with the carbonated beverage under pressure were tested by drop impact tests to examine visually the extent of delamination in the bottle after the drop impact before and after opening the bottles. In each case 10 bottles were dropped in the vertical mode and 10 bottles were dropped in the horizontal mode. In contrast to the comparative example 4 which showed up to 50% delamination, the examples of this invention showed little (<10%) to no delamination at all after the drop impact stress tests.

### Comparative Examples 1-4

Comparative examples 1-4 are used as reference points for comparison with the examples described later.

Comparative example 1 uses a nylon 6 nanocomposite (Honeywell XA-2908) containing 2 weight percent of a nanoclay derived from in-situ polymerization with Nanocor's Nanomer I24.T clay.

Comparative example 2 uses a nylon 6 nanocomposite (Honeywell XA-2979) containing 4 weight percent of a nanoclay derived from in-situ polymerization with Nanocor's Nanomer I24.T clay.

Comparative example 3 uses an amorphous, semi-aromatic polyamide PA-6I/6T (Dupont's Selar PA3426 or PA2072)

Comparative example 4 uses a crystallizable semi-aromatic polyamide PA-MXD6 (Mitsubishi Gas Chemical Co., Nylon-MXD6 grade 6007).

The key properties of these comparative examples and their corresponding 3-layer PET bottle properties are listed in Table 1.

### Examples 1-4

Examples 1-11 illustrate the effect of the inventive polyamide compositions.

Example 1 is a polyamide blend composition comprising of 30 wt % of a PA-6 Nanocomposite (Honeywell XA-2908 w/2% nanoclay) as polyamide component A, 45 wt % of PA-MXD6 (Mitsubishi Gas Chemical's Nylon-MXD6-6007) as polyamide component B, 25 wt. % amorphous nylon PA-6I/6T (Selar PA2072 from DuPont) as polyamide component C. The blend formulation was prepared via a melt blending process on an 18 mm Leistritz twin-screw extruder (Process 1) and pelletized into solid chips as usual. The pellets after drying were processed into a cast film (process 2). The CO₂ barrier of this film was in the desirable range with a low CO₂TR of 1.4 cc.mil/100 in²/day @ 80% RH. As outlined in Table 1, this composition exhibited a substantial improvement in the delamination resistance relative to the comparative examples 1-4, when it was used as the middle layer in the 3-layer PET bottles by coinjection stretch-blow molding (process 3).

Example 2 comprises of a blend of 40 wt % PA-6 Nanocomposite (with 2% nanoclay), 45 wt % PA-MXD6 and 15 wt % amorphous nylon PA-6I/6T. This composition was also compounded via a similar melt blending process (Process 1) and the resulting blend was subsequently processed either into a cast film via process 2 or made into 3-layer PET bottles (Process 3). The CO₂ barrier of the cast film was found to have desirable low CO₂TR value of 1.3 cc.mil/100 in²/day @ 80% RH. Relative to the comparative examples, this formulation showed a significantly slower crystallization rate e.g. in the isothermal DSC tests, the time to reach peak crystallization rate (Tₚₑₐₖ) was 38.8 min compared to 5.3 min. for comparative example 4. Hence there was a substantial improvement in the delamination resistance when fabricated as the middle layer in the 3-layer PET bottles, as compared to the comparative examples. The bottles were subjected to a vertical drop test after filling with soda and they survived this test with negligible delamination.

Example 3 comprises of a blend of 50 wt % PA-6 Nanocomposite (with 2% nanoclay), 40 wt % PA-MXD6 and 10 wt % amorphous nylon PA-6I/6T. This sample was made as in Example 1. The CO₂ barrier of the cast film had an acceptable CO₂TR value of 1.8 cc.mil/100 in²/day (80% RH. Relative to the comparative examples, this formulation also showed a substantial improvement in the delamination resistance in the 3-layer PET bottles.

Example 4 comprises of a blend of 50 wt % PA-6 Nanocomposite (with 4% nanoclay), 45 wt % PA-MXD6 and 10 wt % of amorphous nylon PA-6I/6T. This sample was made as in Example 1. The CO₂ barrier of the cast film had an acceptable CO₂TR value of 1.4 cc.mil/100 in²/day @ 80% RH. Relative to the comparative examples, this formulation also showed a substantial improvement in the delamination resistance in the 3-layer PET bottles.

Example 5 comprises of a blend of 32 wt % PA-6 (Honeywell's H-73, FAV=73), 58 wt % PA-MXD6 and 10 wt % amorphous nylon PA-6I/6T. This composition was prepared as in examples 1 & 2. Relative to the comparative examples, this formulation showed a significantly slower crystallization rate e.g. in the isothermal DSC tests, the time to reach peak crystallization rate (Tₚₑₐₖ) was 48.4 min compared to 5.3 min. for comparative example 4. Consequently there was noted a substantial improvement in the delamination resistance when it was used as the middle layer in the 3-layer PET bottles, compared to the comparative examples. The bottles (soda-filled) survived drop tests with essentially no delamination. The CO₂ barrier of the 3-layer PET bottle made with 5% of this composition as mid-layer was quite good, having a CO₂TR value of 0.56 cc/package/day @80% RH, comparable to comparative example 4 which is a high barrier nylon (CO₂TR value of 0.49) but with poor delamination resistance, whereas Example 5 showed very high delamination resistance.

Examples 6, 7, and 8 illustrate the use of PA-6 copolymers to achieve blend compositions with very slow to no crystallization tendency, while still retaining the desired barrier & glass transition temperatures. They were made and characterized similar to Examples 1-5.

The high delamination and haze levels in multilayer PET bottles derived from comparative examples 1 and 2 (Table 1) seem to indicate an inherent correlation between the high crystallization rates and crystallinities in these polyamides to the lack of adhesion and clarity between these materials and PET when processed into multilayer bottles even at as low as 3 to 5 w % loading levels.

The high haze levels in bottles containing layers of comparative example 3, comprising entirely of amorphous, semi-aromatic nylon, PA-6I/6T led to substantial haze due to crazing and voiding in the nylon layer, when processed into multilayer PET bottles. The voiding and micro-cracking occurred primarily during the stretch blow molding process. Amorphous nylon has a glass transition temperature (T_{g}) as listed in Table 1 of approximately 125° C. Since the T_{g} is above the upper limit of the injection stretch blow temperature (100° C.) of PET, amorphous nylon is unable to stretch without defects forming. Consequently, amorphous nylon develops crazes which results in a high bottle haze level. The crazes and micro-cracks developed in the pure amorphous nylon layer can be readily observed by optical microscopy.

The comparative example 4 exhibits high CO₂ barrier in the neat film as well as in the multilayer PET bottles but it exhibits high delamination tendency particularly after filling with carbonated beverages under pressure and storage. The delamination is particularly aggravated under drop impact stress on the filled bottles. This is again correlatable to the high crystallinities (37%) and crystallization rate (Isothermal DSC data) observed (Table 1) compared to the Examples 1-11.

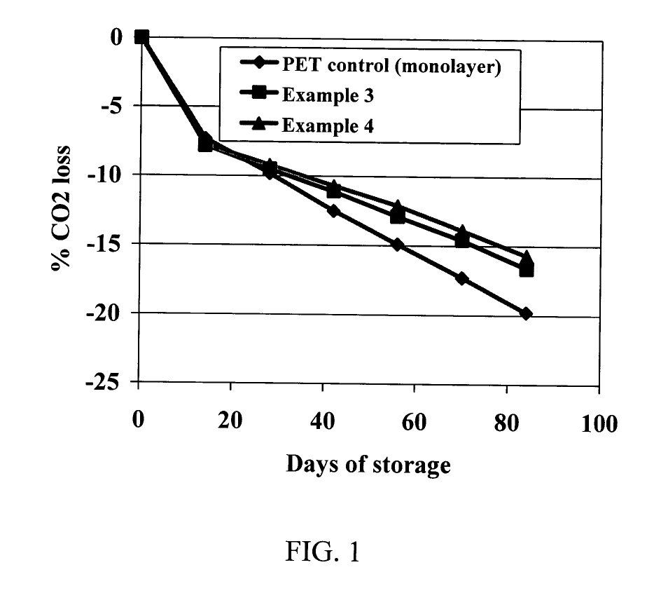

Examples 1-8 of this invention utilize a polyamide blend approach to improve the delamination resistance of the polyamide compositions while maintaining a high CO₂ gas barrier and ease of stretch blow moldability in multilayer PET bottles. The stretch blow processability of bottles requires the T_{g} of the polyamide blend to be <100 C, which was achieved in our inventive compositions. These novel blends also result in significantly lower crystallization rate as characterized by isothermal and non-isothermal DSC tests and consequently a significant improved delamination resistance was obtained in the multilayer bottles, even after filling with soda and drop-impacting the bottles (Table 1). The blend formulations of this invention uniquely combine the desired low CO₂ permeability, easy co-injection stretch blow moldability with PET and an excellent delamination resistance and storage shelf-life (FIG. 1) in the 3-layer PET soda bottles.

TABLE 1
Examples and properties of the polyamide blend compositions and the corresponding 3-layer, coinjection stretch blow molded PET bottles.

| | | Polyamide blend properties | | | | | | PET/PA-b multilayer bottle properties | | | | |
|---|---|---|---|---|---|---|---|---|---|---|---|---|
| | | | | | | | Melt | CO₂TR | | | PA-layer | |
| | Polyamide | | | Isothermal DSC | | | Crystallizn. | (cc.mil/ | CO₂TR | | delamination tendency | |
| | blend | | | crystallization | | | temperature | 100 in²/ | (cc.pkg/ | | | Vertical drop |
| | (PA-b) | Tg; | % | @ 195-200° C. | | | T_{cc} (° C.) | day) @ | d) @ | | | test filled |
| | composition | Tm | Crystallinity | tₚₑₐₖ | ΔHc | Rate | (cooling | 80% RH | 80% RH | | As | with soda |
| Example | (% by wt.) | (° C.) | (XRD) | (min) | (J/g) | (%/min) | 20° C./min) | (Film) | (Bottle) | Haze | molded | & aged |
| Comp. | PA-6 NC2 | 50 | 35 | 8 | 51.7 | 16.8 | 176 | 4.2 | — | Low to | high | — |
| Ex. 1 | (100) | | | | | | | | | med. | | |
| Comp. | PA-6 NC4 | 50 | 40 | 2 | 50.5 | 14 | 177 | 2.4 | — | high | high | — |
| Ex. 2 | (100) | | | | | | | | | | | |
| Comp. | PA-6I/6T (100) | 125 | 0 | nil | 0 | 0 | nil | 4.5 | — | High | — | — |
| Ex. 3 | | | | | | | | | | crazing | | |
| Comp. | PA-MXD6 | 85 | 37 | 5.3 | 49 | 19 | 163 | 1.4 | 0.49 | none | low to | High |
| Ex. 4 | (100) | | | | | | | | | | med. | delamination |
| | | | | | | | | | | | | (>50%) |
| Ex. 1 | PA6-NC2 (30), | — | | | | — | — | 1.4 | 0.69 | None | None | negligible |
| | PA6I/6T (25), | | | | | | | | | | | |
| | PA-MXD6 (45) | | | | | | | | | | | |
| Ex. 2 | PA6-NC2 (40), | 85; | 29 | 38.8 | 11.4 | 6.4 | 141 | 1.3-2.2 | 0.69 | None | None | negligible |
| XA3077 | PA6I/6T (15), | 214, | | | | | | | | | | |
| | PA-MXD6 (45) | 231 | | | | | | | | | | |
| Ex. 3 | PA6-NC2 (50), | 80; | | — | — | | | 1.8 | — | None | | — |
| | PA6I/6T (10), | 214, | | | | | | | | | | |
| | PA-MXD6 (40) | 231 | | | | | | | | | | |
| Ex. 4 | PA6-NC4 (50), | — | | | | | | 1.4 | — | low | none | low |
| | PA6I/6T (10), | | | | | | | | | | | |
| | PA-MXD6 (40) | | | | | | | | | | | |
| Ex. 5 | PA6 (32), | 90; | 9 | 48.4 | 8.3 | 6.4 | 155 | | 0.56 | none | none | none |
| XC3077 | PA6I/6T (10), | 208, 234 | | | | | | | | | | |
| | PA-MXD6 (58) | | | | | | | | | | | |
| Ex. 6 | PA6 (40), | 80; | 9 | | | | 144 | | 0.5 | none | none | none |
| | PA6I/6T (10), | 208, 234 | | | | | | | | | | |
| | PA-MXD6 (50) | | | | | | | | | | | |
| Ex. 7 | PA6 (20), PA6/ | —; | — | nil. | 0 | 0 | 149 | | | — | — | — |
| | 66 (20), | 230 | | | | | | | | | | |
| | PA-MXD6 (60) | | | | | | | | | | | |
| Ex. 8 | PA6/6T(70/30) | 81; | 0 | — | — | — | — | 4.5 | | | | |
| | copolymer | 225 | | | | | | | | | | |
| | (50), | | | | | | | | | | | |
| | PA-MXD6 | | | | | | | | | | | |
| | (50) | | | | | | | | | | | |
| Control | PET monolayer | 77; | | — | — | — | 193 | 19.6 | 1.33 | none | — | — |
| | | 255 | | | | | | | | | | |

1. A polyamide composition comprising a slow crystallizing blend of (i) an aliphatic, crystallizable polyamide homopolymer or copolymer or polyamide nanoclay; (ii) a semi-aromatic, crystallizable polyamide; and (iii) a semi-aromatic, amorphous polyamide.

2. The composition of claim 1 wherein (i) comprises a polyamide nanoclay.

3. The composition of claim 2 wherein said nanoclay comprises montmorillonite.

4. The composition of claim 1 wherein said aliphatic, crystallizable polyamide homopolymer or polyamide copolymer comprises an aliphatic, crystallizable polyamide having a backbone structure of
—HN(CH₂)ₙCO—
wherein n=4 to 10.

5. The composition of claim 1 wherein said aliphatic, crystallizable polyamide homopolymer or polyamide copolymer comprises an aliphatic, crystallizable polyamide nanocomposite having a polyamide backbone structure of
—HN(CH₂)ₙCO—
wherein n=4 to 10 and wherein said nanocomposite comprises an exfoliated, platelet-type nanoclay.

6. The composition of claim 5 wherein said nanocomposite comprises from more than 0% to about 10% by weight of said nanoclay.

7. The composition of claim 5 wherein said exfoliated, platelet-type nanoclay is at least about 20 nm in length, at least about 20 nm in width and has a thickness of at least about 1 nm.

8. The composition of claim 1 wherein said semi-aromatic, crystallizable polyamide comprises a semi-aromatic, crystallizable polyamide having a generalized repeating unit structure which comprises either
—HN(CH₂)ₙAr(CH2)ₙNHCO-Z-CO—; I:
—HN(CH₂)ₙNH—[COArCO—]ₓ—[CO(CH2)ₘ CO]_{y}—; or II:
—HN(CH₂)ₙArCO—; III:
or a combination thereof; wherein n=1 to 3, m=4 to 8, and x+y=1;
wherein Ar=an arylene group; and wherein Z=an alkylene group of C₄ to C₈ or an arylene group of C₆ to C₁₄.

9. The composition of claim 1 wherein said semi-aromatic, crystallizable polyamide comprises a semi-aromatic, crystallizable polyamide having a repeating unit structure which comprises:
—HN(CH₂)ₙAr(CH₂)ₙNHCO-Z-CO—;
wherein n=1 to 3; wherein Ar=an arylene group; and wherein Z=an alkylene group of C₄ to C₈ or an arylene group of C₆ to C₁₄.

10. The composition of claim 9 wherein said semi-aromatic, crystallizable polyamide is selected from the group consisting of PA-MXD6, PA-MXD6/PXD6 (70/30), PA-MXDT and PA-MXDT/MXD6.

11. The composition of claim 1 wherein said semi-aromatic, crystallizable polyamide comprises a semi-aromatic, crystallizable polyamide having a repeating unit structure which comprises:
HN(CH₂)ₙNH—[COArCO—]ₓ—[CO(CH₂)ₘCO]_{y}—;
wherein n=1 to 3, m=4 to 8, and x+y=1; wherein Ar=an arylene group;
and wherein Z=an alkylene group of C₄ to C₈ or an arylene group of C₆ to C₁₄.

12. The composition of claim 11 wherein said semi-aromatic, crystallizable polyamide is selected from the group consisting of PA-6T/66, PA6T/6 and PA-6N/66.

13. The composition of claim 1 wherein said semi-aromatic, crystallizable polyamide comprises a semi-aromatic, crystallizable polyamide having a repeating unit structure which comprises:
—HN(CH₂)ₙArCO—;
wherein n=1 to 3; and wherein Ar=an arylene group.

14. The composition of claim 13 wherein said semi-aromatic, crystallizable polyamide is selected from the group consisting of poly(m-aminomethyl benzoic) acid and poly(2-aminomethyl, 6-naphthoic acid).

15. The composition of claim 8 wherein said semi-aromatic, crystallizable polyamide comprises a semi-aromatic, crystallizable polyamide having a repeating unit structure which comprises a combination of I and II, I and III, 11 and III, or I, II and III.

16. The composition of claim 1 wherein said semi-aromatic, amorphous polyamide comprises a semi-aromatic, amorphous polyamide having a repeat unit structure of:
—HN(CH₂)ₙNH—COArCO—
wherein n=4 to 10 and Ar=a substituted or unsubstituted arylene group.

17. The composition of claim 16 wherein said semi-aromatic, amorphous polyamide comprises a polyamide selected from the group consisting of PA-6I/6T, PA-6I, PA-6/MXDI, PA-6/MXDT and PA-TDAI.

18. The composition of claim 1 wherein said polyamide composition comprises from about 5 to 90 percent by weight of (i), from about 5 to about 90 percent by weight of (ii), and from about 5 to about 90 percent by weight of (iii).

19. The composition of claim 2 wherein said polyamide composition comprises from about 15 to about 75 percent by weight of (i), about 20 to about 70 percent by weight of (ii), and about 10 to about 70 percent by weight of (iii).

20. The composition of claim 1 wherein said aliphatic, crystallizable polyamide homopolymer or copolymer comprises nylon 6 or nylon 6 nanocomposite.

21. The composition of claim 1 wherein said semi-aromatic, crystallizable polyamide comprises PA-MXD6.

22. The composition of claim 1 wherein said semi-aromatic, amorphous polyamide comprises PA-6I/6T.

23. The composition of claim 1 wherein said aliphatic, crystallizable polyamide homopolymer or copolymer comprises nylon 6 or nylon 6 nanocomposite; said semi-aromatic, crystallizable polyamide comprises PA-MXD6; and said semi-aromatic, amorphous polyamide comprises PA-6I/6T.

24. A multilayer film which comprises:
a) at least one polyamide composition layer comprising a slow crystallizing polyamide blend of:
(i) an aliphatic, crystallizable polyamide homopolymer or copolymer or polyamide nanoclay;
(ii) a semi-aromatic, crystallizable polyamide; and
(iii) a semi-aromatic, amorphous polyamide; and
b) at least one thermoplastic polymer layer on one or both sides of said at least one polyamide composition layer.

25. The multilayer film of claim 24 wherein said thermoplastic polymer comprises polyethylene terephthalate.

26. The multilayer film of claim 24 wherein said thermoplastic polymer comprises a polyolefin or polyester.

27. The multilayer film of claim 24 wherein said aliphatic, crystallizable polyamide homopolymer or copolymer comprises nylon 6 or nylon 6 nanocomposite.

28. The multilayer film of claim 24 wherein said semi-aromatic, crystallizable polyamide comprises PA-MXD6.

29. The multilayer film of claim 24 wherein said semi-aromatic, amorphous polyamide comprises PA-6I/6T.

30. The multilayer film of claim 24 wherein said aliphatic, crystallizable polyamide homopolymer or copolymer comprises nylon 6 or nylon 6 nanocomposite; said semi-aromatic, crystallizable polyamide comprises PA-MXD6; and said semi-aromatic, amorphous polyamide comprises PA-6I/6T.

31. The multilayer film of claim 24 wherein said layered nanoclay comprises montmorillonite.

32. The multilayer film of claim 24 wherein said thermoplastic polymer layer and said at least one polyamide composition layer are attached to one another by coextrusion, lamination or coinjection.

33. The multilayer film of claim 24 comprising a thermoplastic polymer layer on both sides of said at least one polyamide composition layer.

34. The multilayer film of claim 24 wherein said aliphatic, crystallizable polyamide homopolymer or copolymer comprises nylon 6 or nylon 6 nanocomposite; said semi-aromatic, crystallizable polyamide comprises PA-MXD6; said semi-aromatic, amorphous polyamide comprises PA-6I/6T; and said thermoplastic polymer layer comprises polyethylene terephthalate.

35. The multilayered film of claim 24 which has an oxygen transmission rate of about 2 cc.mil/100 in²/day or less.

36. The multilayered film of claim 24 which has a carbon dioxide (CO₂) transmission rate of less than about 10 cc.mil/100 in₂/day at 80% relative humidity in air.

37. An article formed from the multilayered film of claim 24.

38. The article of claim 37 which is a bottle.

39. A process for producing a multilayer article which comprises:
(a) melting a polyamide blend comprising of (i) an aliphatic, crystallizable polyamide homopolymer or copolymer, or polyamide nanocomposite; (ii) a semi-aromatic, crystallizable polyamide; and (iii) a semi-aromatic, amorphous polyamide;
(b) separately melting a thermoplastic polymer;
(c) coextruding, casting, blowing, thermoforming, blow molding or co-injecting the polyamide blend and thermoplastic polymer composition into a multilayer article; and
(d) cooling the article.

40. The process of claim 39 wherein said article is in the form of a film, a bottle or a container.

41. The process of claim 39 wherein said article is a film which is subsequently oriented.

42. A process for producing a multilayer article which comprises:
(a) melting a polyamide blend comprising of (i) an aliphatic, crystallizable polyamide homopolymer or copolymer, or polyamide nanocomposite; (ii) a semi-aromatic, crystallizable polyamide; and (iii) a semi-aromatic, amorphous polyamide;
(b) separately melting a thermoplastic polymer;
(c) co-injecting molding the mixture and thermoplastic polymer composition into a multilayer pre-form;
(d) reheating the pre-form; and
(e) blow molding the pre-form into a multilayer article.
